(19) United States
(12) Patent Application Publication
(10) Pub. No.: US 2015/0240874 A1
(43) Pub. Date: Aug. 27, 2015

(54) METHOD TO MOUNT A ROLLING BEARING ON A WIND TURBINE SHAFT AND A WIND TURBINE BEARING ASSEMBLY

(71) Applicant: AKTIEBOLAGET SKF, Göteborg (SE)

(72) Inventors: Hans Wendeberg, Vastra Frolunda (SE); Håkan Leander, Torslanda (SE)

(21) Appl. No.: 14/426,816

(22) PCT Filed: Sep. 2, 2013
(86) PCT No.: PCT/SE2013/000135

§ 371 Date: Mar. 9, 2015

(30) Foreign Application Priority Data
Sep. 7, 2012 (SE) 1200546-8

(51) Int. Cl. F16C 35/063; F16C 43/04; F03D 11/00; F16C 33/80

(52) U.S. Cl. CPC F16C 35/0635; F16C 33/80; F16C 43/04; F03D 11/0008

(57) ABSTRACT

The invention is a method of mounting a rolling bearing onto a wind turbine rotor shaft, wherein the bearing includes an outer ring, an inner ring and rolling elements disposed between the rings, and wherein the inner ring provides an inner circumferential surface, having a frustoconical profile. The rolling bearing is mounted on a corresponding conical seat on the rotor shaft by the frustoconical inner circumferential surface. The method includes: pressing a liquid in-between the inner circumferential surface of the inner ring and the conical seat to facilitate the driving up of the rolling bearing on the conical seat, driving up the rolling bearing on the conical seat by an axial force acting on the rolling bearing, wherein the liquid is pressed in-between the two surfaces at an axial end portion of the inner circumferential surface. Furthermore, the invention regards a bearing assembly.

### FIELD OF THE INVENTION

The present invention relates to bearing assemblies in wind turbines. More particularly, the invention concerns a method to mount a rolling bearing on a rotor shaft in a wind turbine and a bearing assembly design.

### BACKGROUND OF THE INVENTION

One frequently used design for a wind turbine is to use a rotor shaft to connect a rotor of the wind turbine to a generator to thereby transfer rotational energy to the generator, which in turn generates electricity. The rotor shaft is supported by at least one or two bearings. The bearings can be mounted on conical seats on the rotor shaft, wherein the inner bore of such a bearing presents a corresponding frusto-conical profile. In order to facilitate the mounting of such a bearing, oil is pressed in-between the contacting surfaces of the bearing and the rotor shaft via a drilled bore in the rotor shaft, wherein the drilled bore ends at the conical mounting seat of the rotor shaft.

### SUMMARY OF THE INVENTION

It has been found by the inventors that such a drilled bore in the rotor shaft may reduce the strength of the shaft. Therefore, it has been realized that there is a need to propose a new method and design in order to avoid the discovered drawback of the current design.

An object of the invention is thus to propose a new method and design that avoids at least one of the drawbacks of the prior art and that specifically leads to a design that increases the strength of the wind turbine and its rotor shaft. The objects have been achieved by the method and the bearing assembly as defined in the independent claims.

According to a first aspect, the objects are achieved by a method to mount a rolling bearing onto a wind turbine rotor shaft, wherein the bearing presents an outer ring, an inner ring and rolling elements interposed in-between the rings, and wherein the inner ring presents an inner circumferential surface, which surface presents a frusto-conical profile. The rolling bearing is meant to be mounted on a corresponding conical seat on the rotor shaft by the frusto-conical inner circumferential surface. The method comprises the following steps:
pressing a liquid in-between the inner circumferential surface of the inner ring and the conical seat to thereby facilitate the driving up of the rolling bearing on the conical seat,
driving up the rolling bearing on the conical seat by an axial force acting on the rolling bearing,
wherein the liquid is pressed in-between the two surfaces at an axial end portion of the inner circumferential surface.

This method has the advantage that there is no need to drill a bore in the rotor shaft of the wind turbine. This will lead to that the shaft will have an improved strength compared to shafts with drilled bores. To have a rigid and robust design of the wind turbine rotor assembly is of high importance to thereby avoid unnecessary maintenance and repair work. The rotor assembly is mounted into a nacelle of the wind turbine, which is located high up above the ground level. Therefore, repair work and maintenance can be costly and also difficult to perform.

In an embodiment of the method, the liquid is any of oil, synthetic oil or other non-corrosive fluid.

In an embodiment of the method, a ring is mounted on the shaft and is located adjacent to and in contact with the axial end portion of the inner ring, wherein the liquid is pressed in-between the two surfaces via a conduit in the ring, which conduit ends proximate the axial end portion of the inner circumferential surface.

According to the second aspect of the invention, the objects are achieved by a wind turbine bearing assembly, which comprises:
a rotor shaft,
a rolling bearing, wherein the rolling bearing presents an outer ring, an inner ring and rolling elements interposed in-between the rings, and wherein the inner ring presents an inner circumferential surface, which surface presents a frusto-conical profile, and wherein the rolling bearing is mounted on a corresponding conical seat on the rotor shaft by the frusto-conical inner circumferential surface.

The bearing assembly further comprises a first ring mounted on the shaft and contacting at least the inner ring at an axial end portion of the rolling bearing, and wherein the first ring further presents a conduit, wherein the conduit ends proximate the axial end portion of the inner circumferential surface.

This design has the advantage that there is no need to drill a bore in the rotor shaft of the wind turbine. Instead there is a conduit in the labyrinth ring where a liquid, such as oil, will be pressed in between the inner ring and the shaft. This will lead to that the shaft will have an improved strength compared to shafts with drilled bores. To have a rigid and robust design of the wind turbine rotor assembly is of high importance to thereby avoid unnecessary maintenance and repair work. The rotor assembly is mounted into a nacelle of the wind turbine, which is located high up above the ground level. Therefore, repair work and maintenance can be costly and also difficult to perform.

All embodiments of the first aspect are applicable to all embodiments of the second aspect and vice versa.

In an embodiment of the invention, the first ring is a labyrinth ring, wherein the labyrinth ring contacts at least the inner ring and the outer ring at an axial end portion of the rolling bearing, and wherein the labyrinth ring seals off a space between the outer and inner ring. In another embodiment, the first ring is any of a ring-shaped part of a bearing housing, a seal or a bearing inner ring locating arrangement or any other suitable ring.

In an embodiment, the rolling bearing is any of a toroidal roller bearing, a spherical roller bearing, a tapered roller bearing, a cylindrical roller bearing, or any other suitable rolling bearing for a wind turbine bearing assembly.

In an embodiment of the bearing assembly, the assembly further presents a second labyrinth ring mounted on the shaft and contacting the inner ring and the outer ring on the other axial end portion of the rolling bearing, wherein the second labyrinth ring seals off a second space between the outer and inner ring.

In an embodiment of the bearing assembly, the assembly comprises a third ring mounted on the shaft and being adjacent the first labyrinth ring, wherein the first labyrinth ring, the third ring and the shaft are configured to create a circumferential cavity in a circumferential extension around the shaft.

In an embodiment of the bearing assembly, the cavity is meant to act as a pressure chamber for mounting the bearing on the shaft by axially driving up the bearing on the conical seat on the shaft.

In an embodiment of the bearing assembly, the shaft presents a circumferential groove, and wherein the third ring is meant to be axially fixed on the shaft between the first labyrinth ring and a metal wire in the groove.

### BRIEF DESCRIPTION OF DRAWINGS

Below, a more detailed description of a number of preferred embodiments will be described. It should be noted that the accompanying drawings are not drawn to scale, and in some cases specific details may have been exaggerated in order to better explain the invention. Furthermore, the invention as claimed is not limited to the embodiments described and shown, but modifications are possible for a skilled person within the scope of the claims.

FIG. 1 shows an embodiment of an axial cross section of a wind turbine bearing assembly according to the invention.

FIG. 2 shows a flow chart of the method according to the invention.

### DETAILED DESCRIPTION

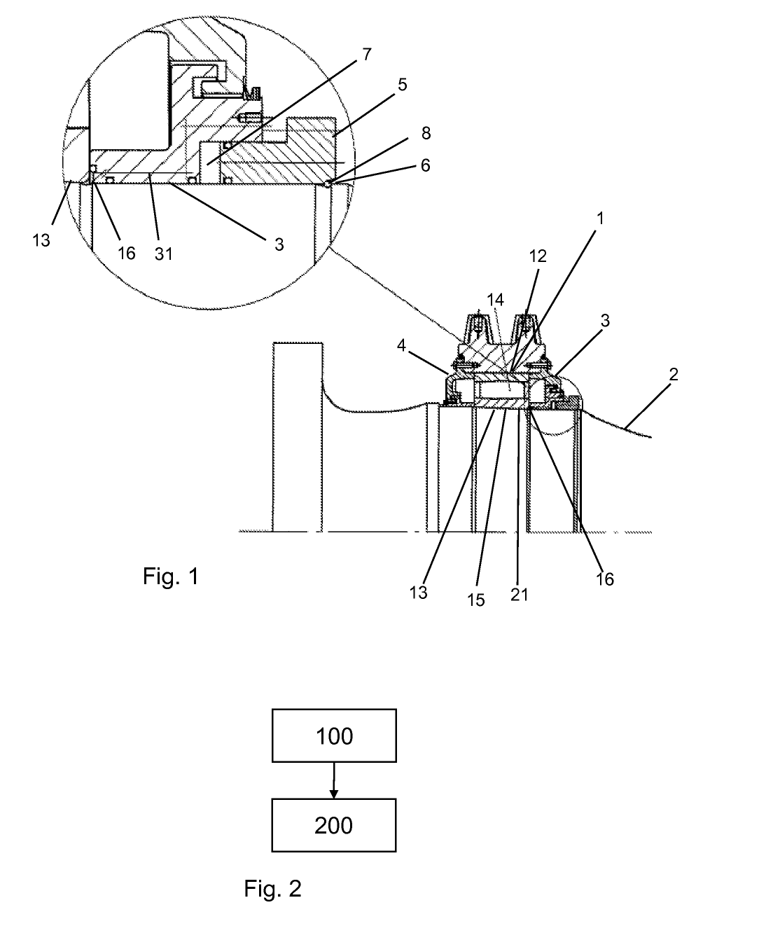

FIG. 1 shows an embodiment of an axial cross section of a wind turbine bearing assembly according to the invention. The assembly comprises:
a rotor shaft 2,
a rolling bearing 1, wherein the rolling bearing presents an outer ring 12, an inner ring 13 and rolling elements 14 interposed in-between the rings, and wherein the inner ring 13 presents an inner circumferential surface 15, which surface presents a frusto-conical profile, and wherein the rolling bearing 1 is mounted on a corresponding conical seat 21 on the rotor shaft by the frusto-conical inner circumferential surface (15). The bearing assembly further comprises a first labyrinth ring 3 mounted on the shaft 2 and contacting the inner ring 13 and the outer ring 14 at an axial end portion of the rolling bearing 1, wherein the first labyrinth ring 3 seals off a space between the outer and inner ring 12, 13, and wherein the first labyrinth ring 3 further presents a conduit 31, wherein the conduit 31 ends proximate the axial end portion 16 of the inner circumferential surface 15.

FIG. 2 shows a flowchart of the method according to the invention. The method comprises the steps of:
(100) pressing a liquid in-between the inner circumferential surface 15) of the inner ring 13 and the conical seat 21 to thereby facilitate the driving up of the rolling bearing 1 on the conical seat 21,
(200) driving up the rolling bearing 1) on the conical seat 21 by an axial force acting on the rolling bearing 1,
wherein the liquid is pressed in-between the two surfaces 15, 21 at an axial end portion 16 of the inner circumferential surface.

1. A method of mounting a rolling bearing onto a wind turbine rotor shaft, the bearing provides an outer ring, an inner ring and rolling elements between the rings, the inner ring including an inner circumferential surface, the surface having a frusto-conical profile, and wherein
the rolling bearing is mounted on a corresponding conical seat on the rotor shaft by the frusto-conical inner circumferential surface, the method comprising:
pressing a liquid in-between the inner circumferential surface of the inner ring and the conical seat to thereby facilitate the driving up of the rolling bearing on the conical seat,
driving up the rolling bearing on the conical seat by an axial force acting on the rolling bearing,
wherein the liquid is pressed in-between the two surfaces at an axial end portion of the inner circumferential surface.

2. The method according to claim 1, wherein the liquid is any of oil, synthetic oil or other non-corrosive fluid.

3. The method according to claim 1, wherein a ring is mounted on the shaft and located adjacent to and in contact with the axial end portion of the inner ring,
wherein the liquid is pressed in-between the two surfaces via a conduit in the ring, and wherein
the conduit ends proximate the axial end portion of the inner circumferential surface.

4. A wind turbine bearing assembly, comprising,
a rotor shaft,
a rolling bearing, the bearing provides an outer ring, an inner ring and rolling elements between the rings, the inner ring including an inner circumferential surface, the surface having a frusto-conical profile, and wherein
the rolling bearing is mounted on a corresponding conical seat on the rotor shaft by the frusto-conical inner circumferential surface,
wherein the bearing assembly further includes a first ring mounted on the shaft and contacting at least the inner ring at an axial end portion of the rolling bearing
wherein the first ring (3) further includes a conduit, and wherein the conduit ends proximate a first axial end portion of the inner circumferential surface.

5. The wind turbine bearing assembly according to claim 4,
wherein the first ring (3) is one of:
a labyrinth ring, wherein the labyrinth ring is contacting at least the inner ring and the outer ring, and wherein the labyrinth ring seals off a space between the outer and inner ring,
a ring-shaped part of a bearing housing,
a seal, and
a bearing inner ring locating arrangement.

6. The wind turbine bearing assembly according to claim 4,
wherein the assembly further presents a second labyrinth ring mounted on the shaft and contacting the inner ring and the outer ring on axial end portion of the rolling bearing, wherein the second labyrinth ring seals off a second space between the outer and inner ring.

7. The wind turbine bearing assembly according to claim 4,
further comprising a third ring mounted on the shaft and being adjacent the first ring, wherein the first ring, the third ring and the shaft are configured to create a circumferential cavity in a circumferential extension around the shaft.

8. The wind turbine bearing assembly according to claim 7,
wherein the cavity is meant to act as a pressure chamber for mounting the bearing on the shaft by axially driving up the bearing on the conical seat on the shaft.

9. The wind turbine bearing assembly according to claim 7,
wherein the shaft provides a circumferential groove, and wherein the third ring is axially fixed on the shaft between the first ring and a metal wire in the groove.
